(19) United States
(12) Patent Application Publication
(10) Pub. No.: US 2024/0043646 A1
(43) Pub. Date: Feb. 8, 2024

(54) PRODUCTION OF POLYURETHANE FOAM

(71) Applicant: EVONIK OPERATIONS GMBH, Essen (DE)

(72) Inventors: Michael SUCHAN, Gelsenkirchen (DE); Michael FERENZ, Essen (DE); Carsten SCHILLER, Ratingen (DE)

(73) Assignee: EVONIK OPERATIONS GMBH, Essen (DE)

(21) Appl. No.: 18/265,430

(22) PCT Filed: Nov. 22, 2021
(86) PCT No.: PCT/EP2021/082463

§ 371 Date: Jun. 5, 2023

(30) Foreign Application Priority Data
Dec. 8, 2020 (EP) 20212361.8

(51) Int. Cl. C08J 9/00; C08G 77/445; C08G 18/76; C08G 18/42; C08G 18/61; C08J 9/14

(52) U.S. Cl. CPC C08J 9/0061; C08G 77/445; C08G 18/7664; C08G 18/4208; C08G 18/61; C08J 9/141; C08G 2110/0025; C08J 2375/04; C08J 2205/10; C08J 2483/10

(57) ABSTRACT

Composition for producing polyurethane foam, in particular rigid polyurethane foam, comprising at least an isocyanate component, a polyol component, optionally a catalyst that catalyses the formation of a urethane or isocyanate linkage, blowing agents, wherein the composition comprises polyester-polysiloxane block copolymers.

The present invention relates to the field of polyurethanes, especially that of polyurethane foams. It relates in particular to the production of polyurethane foams using polyester-polysiloxane block copolymers and additionally to the use of these foams. The polyurethane foams here are in particular rigid polyurethane foams.

Polyurethane (PU) in the context of the present invention is especially understood as meaning a product obtainable through reaction of polyisocyanates and polyols or compounds having isocyanate-reactive groups. Further functional groups besides the polyurethane may also be formed in the reaction, for example uretdiones, carbodiimides, isocyanurates, allophanates, biurets, ureas and/or uretonimines. PU is therefore for the purposes of the present invention understood as meaning not just polyurethane, but also polyisocyanurate, polyureas, and polyisocyanate reaction products containing uretdione, carbodiimide, allophanate, biuret and uretonimine groups. In the context of the present invention, polyurethane foam (PU foam) is understood as meaning foam that is obtained as a reaction product based on polyisocyanates and polyols or compounds having isocyanate-reactive groups. In addition to the eponymous polyurethane, further functional groups may also be formed here, for example allophanates, biurets, ureas, carbodiimides, uretdiones, isocyanurates or uretonimines.

A fundamental aim associated with the provision of PU foams, in particular rigid PU foams, is to produce PU foams having good flame-retardant properties. For this reason, corresponding flame retardants having flame-retarding properties are accordingly described in the known prior art. Against this background, there is additionally a great demand for agents that enable good flame-retardant properties in the provision of PU foams.

The specific object of the present invention was in this regard to make it possible to provide PU foams, in particular rigid PU foams, having good flame-retardant properties.

This object is achieved by the subject matter of the invention. The invention provides a composition for producing PU foam, in particular rigid PU foam, comprising at least an isocyanate component, a polyol component, blowing agents, optionally a catalyst that catalyses the formation of a urethane or isocyanurate linkage, the composition comprising polyester-polysiloxane block copolymers.

The subject matter of the invention is associated with various advantages. For instance, it makes possible the provision of PU foams, in particular rigid PU foams, having good flame-retardant properties. Advantageously, this is made possible without adversely affecting the other properties of the foam, in particular its mechanical properties. With regard to the provision of rigid PU foams in particular, foam structures that are particularly fine-celled, uniform and low in defects are moreover made possible. It is thus possible to provide corresponding PU foams having particularly good use properties, there being a positive influence on the thermal insulation performance of rigid PU foams in particular. The invention makes it possible in particular to improve the flame-retardant properties of corresponding PU foams such that the amount of conventional flame retardants used in the production of corresponding PU foams can be reduced. The polyester-polysiloxane block copolymers of the invention additionally act as a foam stabilizer.

Polyester-polysiloxane block copolymers and the production thereof have long been known to those skilled in the art. They can be produced for example through reaction of organofunctional siloxanes with cyclic esters with the addition of catalysts, for example through reaction of hydroxyalkyl siloxanes with ε-caprolactone in the presence of an organotin compound as catalyst. The synthesis of block copolymers that can be used according to the invention is described in the experimental part on the basis of 4 examples.

In a particularly preferred embodiment of the invention, polyester-polysiloxane block copolymers of the formula 1 are used,

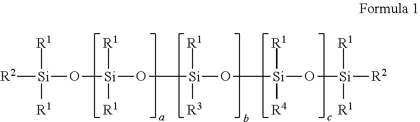

where
R¹=identical or different aliphatic or aromatic hydrocarbon radicals having 1 to 16 carbon atoms, preferably aliphatic or aromatic hydrocarbon radicals having 1 to 8 carbon atoms, in particular methyl or phenyl,
R²=identical or different radicals from the group R¹, R³ or R⁴, preferably R¹,
R³=identical or different polyester radicals, preferably polyester radicals of the formula 2,

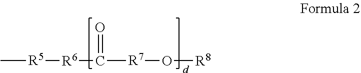

R⁵=identical or different divalent alkyl radicals optionally interrupted by one or more oxygen atoms, preferably —(CH₂)₃—, —(CH₂)₆—, —(CH₂)₃OCH₂CH₂— or —(CH₂)₃OCH₂CH(CH₃)—,
R⁶=O or NH or NMe, preferably O,
R⁷=identical or different divalent alkyl radicals having 1 to 20 carbon atoms, preferably alkyl radicals of the general formula —[CR⁹₂]ₑ—,
R⁹=identical or different alkyl radicals having 1 to 8 carbon atoms or H, preferably methyl or H,
R⁸=identical or different radicals of the general formula —C(O)R¹⁰ or H, preferably H,
R¹⁰=identical or different alkyl radicals having 1 to 16 carbon atoms, preferably methyl,
R⁴=identical or different polyether radicals, preferably identical or different polyether radicals of the formula 3

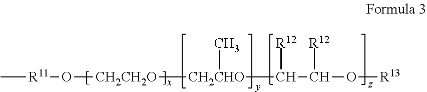

R¹¹=identical or different divalent alkyl radicals having 2 to 12 carbon atoms, preferably divalent alkyl radicals having 3 to 6 carbon atoms, in particular —(CH₂)₃—,
R¹²=identical or different alkyl radicals having 1 to 12 carbon atoms, preferably methyl, ethyl or phenyl,
R¹³=identical or different radicals from the group: —C(O)R¹⁰, H and alkyl radicals having 1-8 carbon atoms, preferably —C(O)CH₃, H or methyl,
a=5-200, preferably 5-100, particularly preferably 10-80,
b=1-20, preferably 1-15, particularly preferably 2-10,
c=0-20, preferably 0-15, particularly preferably 0,
d=2 to 80, preferably 2 to 60, particularly preferably 3 to 40,
e=1-16, preferably 1 to 12, particularly preferably 1 to 6,
x=0 to 80, preferably 0 to 60, particularly preferably 3 to 40,
y=0 to 80, preferably 0 to 60, particularly preferably 3 to 40,
z=0 to 60, preferably 0 to 20, particularly preferably 0,
with the proviso that x+y+z>2,
and with the proviso that at least one radical R³ must be present in the molecule and preferably at least two different radicals R⁷ are present in the molecule.

Corresponding compositions show particularly advantageous results in respect of the above-described advantages of the invention, such as in particular the flame retardancy and foam stabilization.

It corresponds to a further particularly preferred embodiment of the invention when the polyester-polysiloxane block copolymers of the invention are obtained through reaction of cyclic esters, of the cyclic dimers thereof or of higher analogues with alcohol- and/or amino-functional siloxanes, preferably derived from formulas 1 and 2.

In addition, it is preferable that at least two or more different cyclic ethers, selected in particular from propiolactone, lactide, caprolactone, butyrolactone or valerolactone, are used in the production of the polyester-polysiloxane block copolymers of the invention. This corresponds to a further particularly preferred embodiment of the invention.

A further particularly preferred embodiment of the invention is when the polyester-polysiloxane block copolymers are used in a total amount of 0.01 to 15 parts, preferably 0.1 to 10 parts, more preferably 0.1 to 5 parts, based on 100 parts of polyols.

In addition, it has surprisingly been found that the combined use of polyester-polysiloxane block copolymers of the invention with particular blowing agents leads to particularly advantageous results with regard to the advantages of the invention mentioned above, such as in particular the flame retardancy and foam stabilization.

It also corresponds to a particularly preferred embodiment when the composition of the invention uses as blowing agents water, hydrocarbons having 3, 4 or 5 carbon atoms, preferably cyclo-, iso- and/or n-pentane, hydrofluorocarbons, in particular HFC 245fa, HFC 134a and/or HFC 365mfc, chlorofluorocarbons, preferably HCFC 141b, hydrofluoroolefins (HFO) or hydrohaloolefins such as e.g. 1234ze, 1234yf, 1224yd, 1233zd(E) and/or 1336mzz, oxygen-containing compounds such as methyl formate, acetone and/or dimethoxymethane, or chlorinated hydrocarbons, preferably dichloromethane and/or 1,2-dichloroethane, in particular water, cyclo-, iso- and/or n-pentane, 1233zd(E) or 1236mzz.

In addition, it may be possible for the polyester-polysiloxane block copolymers of the invention to contain, in addition to the polyester side chains, also polyether side chains. This corresponds to a further preferred embodiment of the present invention.

The polyester-polysiloxane block copolymers of the invention not only improve the flame-retardant properties of the PU foam, they also act as a foam stabilizer. It even allows the complete replacement of customary foam stabilizers, which are usually polyether siloxanes that in turn contain no polyester side chains. Thus, a composition according to the invention in which siloxane-based foam stabilizers comprising exclusively polyethers (=silicone polyether copolymers containing no polyester side chains) are present to an extent, based on the total amount of foam stabilizers, of less than 15% by weight, preferably less than 10% by weight, in particular less than 5% by weight or not present at all, corresponds to a preferred embodiment of the invention. However, it is also possible to use mixtures with other foam stabilizers, in particular with polyether-containing, siloxane-based foam stabilizers.

It additionally corresponds to a preferred embodiment of the invention when Si-containing foam stabilizers are present in the composition of the invention to an extent, based on the total amount of foam stabilizers, of more than 10% by weight, in particular more than 20% by weight and particularly preferably more than 50% by weight.

The invention further provides a process for producing PU foams, in particular rigid PU foams, based on foamable reaction mixtures comprising polyisocyanates, compounds having reactive hydrogen atoms, blowing agents and optionally other additives, wherein polyester-polysiloxane block copolymers are used, preferably as already described above more particularly, in particular as described above more particularly in the preferred embodiments.

The process of the invention for producing PU foams can be carried out by known methods, for example by manual mixing or preferably by means of foaming machines. If the process is carried out by using foaming machines, it is possible to use high-pressure or low-pressure machines. The process according to the invention can be carried out either batchwise or continuously.

A preferred rigid PU foam formulation in the context of the present invention gives a foam density of 5 to 900 kg/m³ and has the composition shown in Table 1.

TABLE 1
Composition of a preferred rigid PU foam formulation

| | Proportion |
|---|---|
| Component | by weight |
| Polyester-polysiloxane block copolymers of the invention | 0.1 to 5 |
| Polyol | >0 to 99.9 |
| Amine catalyst | 0 to 5 |
| Metal catalyst | 0 to 10 |
| Optional polyether siloxane | 0 to 5 |
| Water | 0 to 20 |
| Blowing agent | >0 to 40 |
| Further additives (flame retardants, etc.) | 0 to 300 |
| Isocyanate index: 10 to 1000 | |

For further preferred embodiments and configurations of the process of the invention, reference is also made to the details already given above in connection with the composition of the invention. The present invention still further provides a PU foam, in particular a rigid PU foam, produced according to the process of the invention mentioned above, in particular using a composition of the invention.

It is a preferred embodiment of the invention when the PU foam, in particular rigid PU foam, of the invention has a foam density of 5 to 900 kg/m³, preferably 5 to 350 kg/m³, in particular 10 to 200 kg/m³.

The present invention further relates to the use of the PU foam, in particular rigid PU foam, of the invention, as mentioned above, as an insulating material and/or as a construction material, especially in construction applications, especially in spray foam or in the refrigeration sector, as acoustic foam for sound absorption, as packaging foam, as headliners for automobiles or pipe jacketing for pipes.

The use of polyester-polysiloxane block copolymers of the invention, in particular as defined in any of the claims, in the production of PU foams, preferably rigid PU foams, in particular with the use of a composition of the invention, in particular as defined in any of the claims, is further provided by the invention, the polyester-polysiloxane block copolymers being used in particular as a foam-stabilizing component in the production of PU foams, preferably rigid PU foams. Preference is given to use in reducing the flammability of PU foam, preferably of rigid PU foam, in particular for improving the fire resistance of the PU foam, preferably the flame resistance, and/or for reducing flame height, in particular with the aim of complying with the fire protection standard of min. B2 according to DIN 4102-1:1998-05.

A preferred composition according to the invention comprises the following constituents:
a) polyester-polysiloxane block copolymers of the invention
b) isocyanate-reactive components, in particular polyols
c) at least one polyisocyanate and/or polyisocyanate prepolymer
d) a catalyst that accelerates/regulates the reaction of polyols b) with isocyanates c)
e) optionally a further silicon-containing compound as surfactant
f) one or more blowing agents
g) optionally further additives, fillers, flame retardants, etc.

It is a preferred embodiment of the invention when the PU foams are produced using a component having at least 2 isocyanate-reactive groups, preferably a polyol component, a catalyst and a polyisocyanate and/or a polyisocyanate prepolymer. The catalyst is introduced here especially via the polyol component. Suitable polyol components, catalysts and polyisocyanates and/or polyisocyanate prepolymers are known per se, but are also described hereinbelow.

Polyols suitable as the isocyanate-reactive component/polyol component b) are for the purposes of the present invention all organic substances having one or more isocyanate-reactive groups, preferably OH groups, and also formulations thereof. Preferred polyols are all polyether polyols and/or polyester polyols and/or hydroxyl-containing aliphatic polycarbonates, in particular polyether polycarbonate polyols, and/or polyols of natural origin, known as “natural oil-based polyols” (NOPs), that are customarily used for producing polyurethane systems, especially polyurethane coatings, polyurethane elastomers or foams. The polyols typically have a functionality of 1.8 to 8 and number-average molecular weights within a range from 500 to 15 000. It is customary to employ polyols having OH values within a range from 10 to 1200 mg KOH/g.

For production of rigid PU foams, preference is given to using polyols or mixtures thereof, with the proviso that at least 90 parts by weight of the polyols present, based on 100 parts by weight of polyol component, have an OH value greater than 100, preferably greater than 150, in particular greater than 200. The fundamental difference between flexible foam and rigid foam is that a flexible foam shows elastic behaviour and is reversibly deformable. When the flexible foam is deformed by application of force, it returns to its starting shape as soon as the force ceases. Rigid foam is by contrast permanently deformed.

Polyether polyols can be produced by known methods, for example by anionic polymerization of alkylene oxides in the presence of alkali metal hydroxides, alkali metal alkoxides or amines as catalysts and with addition of at least one starter molecule that preferably contains 2 or 3 reactive hydrogen atoms in bonded form, or by cationic polymerization of alkylene oxides in the presence of Lewis acids, for example antimony pentachloride or boron trifluoride etherate, or by double metal cyanide catalysis. Suitable alkylene oxides contain 2 to 4 carbon atoms in the alkylene radical. Examples are tetrahydrofuran, 1,3-propylene oxide, 1,2-butylene oxide and 2,3-butylene oxide; ethylene oxide and 1,2-propylene oxide are preferably used. The alkylene oxides may be used individually, cumulatively, in blocks, in alternation or as mixtures. Starter molecules used may in particular be compounds having at least 2, preferably 2 to 8, hydroxyl groups, or having at least two primary amino groups in the molecule. Starter molecules used may for example be water, di-, tri- or tetrahydric alcohols, such as ethylene glycol, propane-1,2- and -1,3-diol, diethylene glycol, dipropylene glycol, glycerol, trimethylolpropane, pentaerythritol, castor oil, etc., higher polyfunctional polyols, especially sugar compounds, for example glucose, sorbitol, mannitol and sucrose, polyhydric phenols, resols, for example oligomeric condensation products of phenol and formaldehyde and Mannich condensates of phenols, formaldehyde and dialkanolamines and also melamine, or amines such as aniline, EDA, TDA, MDA and PMDA, more preferably TDA and PMDA. The choice of suitable starter molecule depends on the respective field of application of the resulting polyether polyol in polyurethane production.

Polyester polyols are based on esters of polybasic aliphatic or aromatic carboxylic acids, preferably having 2 to 12 carbon atoms. Examples of aliphatic carboxylic acids are succinic acid, glutaric acid, adipic acid, suberic acid, azelaic acid, sebacic acid, decanedicarboxylic acid, maleic acid and fumaric acid. Examples of aromatic carboxylic acids are phthalic acid, isophthalic acid, terephthalic acid and the isomeric naphthalenedicarboxylic acids. The polyester polyols are obtained by condensation of these polybasic carboxylic acids with polyhydric alcohols, preferably with diols or triols having 2 to 12, more preferably 2 to 6, carbon atoms, preferably trimethylolpropane and glycerol.

Polyether polycarbonate polyols are polyols containing carbon dioxide bound in the form of the carbonate. Since carbon dioxide is formed in large amounts as a by-product in many processes in the chemical industry, the use of carbon dioxide as comonomer in alkylene oxide polymerizations is of particular interest from a commercial viewpoint. Partial replacement of alkylene oxides in polyols with carbon dioxide has the potential to distinctly lower costs for the production of polyols. Moreover, the use of CO₂ as comonomer is very environmentally advantageous, since this reaction constitutes the conversion of a greenhouse gas into a polymer. The preparation of polyether polycarbonate polyols by addition of alkylene oxides and carbon dioxide to H-functional starter substances with the use of catalysts has long been known. Various catalyst systems may be employed here: The first generation were heterogeneous zinc or aluminium salts, as described e.g. in U.S. Pat. No. 3,900,424 or US-A 3953383. In addition, mono- and binuclear metal complexes have been used successfully for copolymerization of CO₂ and alkylene oxides (WO 2010/028362, WO 2009/130470, WO 2013/022932 or WO 2011/163133). The most important class of catalyst systems for the copolymerization of carbon dioxide and alkylene oxides is that of double metal cyanide catalysts, also referred to as DMC catalysts (U.S. Pat. No. 4,500,704, WO 2008/058913). Suitable alkylene oxides and H-functional starter substances are those also used for preparing carbonate-free polyether polyols, as described above.

Polyols based on natural oil-based polyols (NOPs) as renewable raw materials for production of PU foams are of increasing interest with regard to the long-term limits on the availability of fossil resources, namely oil, coal and gas, and against the background of rising crude oil prices, and have already been described many times in such applications (WO 2005/033167; US 2006/0293400, WO 2006/094227, WO 2004/096882, US 2002/0103091, WO 2006/116456 and EP 1678232). A number of these polyols are now commercially available from various manufacturers (WO 2004/020497, US 2006/0229375, WO 2009/058367). Depending on the base raw material (e.g. soybean oil, palm oil or castor oil) and subsequent processing, polyols having a varying property profile are obtained. It is possible here to distinguish essentially between two groups: a) polyols based on renewable raw materials that are modified such that they can be used to an extent of 100% for production of polyurethanes (WO 2004/020497, US 2006/0229375); b) polyols based on renewable raw materials that, because of the processing and properties thereof, can replace the petrochemical-based polyol only in a certain proportion (WO 2009/058367).

A further class of employable polyols is that of so-called filled polyols (polymer polyols). The characteristic feature of these is that they contain dispersed solid organic fillers up to a solids content of 40% or more. Usable polyols include SAN, PUD and PIPA polyols. SAN polyols are highly reactive polyols containing a dispersed copolymer based on styrene-acrylonitrile (SAN). PUD polyols are highly reactive polyols containing polyurea, likewise in dispersed form. PIPA polyols are highly reactive polyols containing a dispersed polyurethane, formed for example by in-situ reaction of an isocyanate with an alkanolamine in a conventional polyol.

A further class of employable polyols is that of polyols obtained as prepolymers through reaction of polyol with isocyanate in a molar ratio of preferably 100:1 to 5:1, more preferably 50:1 to 10:1. Such prepolymers are preferably compounded in the form of a solution in polymer, wherein the polyol preferably corresponds to the polyol used for preparing the prepolymers.

A further class of employable polyols is that of so-called recycled polyols, i.e. polyols obtained from recycling polyurethanes. Recycled polyols are known per se. For instance, polyurethanes are cleaved by solvolysis, thereby rendering them into a soluble form. Almost all chemical recycling processes for polyurethanes employ such reactions, e.g. glycolysis, hydrolysis, acidolysis or aminolysis, there being a large number of process variants known in the prior art. The use of recycled polyols represents a preferred embodiment of the invention.

A preferred ratio of isocyanate and polyol, expressed as the index of the formulation, that is to say as the stoichiometric ratio of isocyanate groups to isocyanate-reactive groups (e.g. OH groups, NH groups) multiplied by 100, is within a range from 10 to 1000, preferably 40 to 400. An index of 100 represents a molar ratio of reactive groups of 1:1.

The isocyanate components/polyisocyanate c) used are preferably one or more organic polyisocyanates having two or more isocyanate functions. The polyol components used are preferably one or more polyols having two or more isocyanate-reactive groups.

Isocyanates suitable as isocyanate components are for the purposes of the present invention all isocyanates containing at least two isocyanate groups. It is generally possible to use all aliphatic, cycloaliphatic, arylaliphatic and preferably aromatic polyfunctional isocyanates known per se. Particular preference is given to using isocyanates within a range from 40 to 400 mol % relative to the sum total of the isocyanate-consuming components.

Examples that may be mentioned here include alkylene diisocyanates having 4 to 12 carbon atoms in the alkylene radical, e.g. dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate (HMDI), cycloaliphatic diisocyanates such as cyclohexane 1,3- and 1,4-diisocyanate and also any desired mixtures of these isomers, 1-isocyanato-3,3,5-trimethyl-5-isocyanatomethylcyclohexane (isophorone diisocyanate or IPDI for short), hexahydrotolylene 2,4- and 2,6-diisocyanate and also the corresponding isomer mixtures, and preferably aromatic diisocyanates and polyisocyanates, for example tolylene 2,4- and 2,6-diisocyanate (TDI) and the corresponding isomer mixtures, naphthalene diisocyanate, diethyltoluene diisocyanate, mixtures of diphenylmethane 2,4′- and 2,2′-diisocyanates (MDI) and polyphenyl polymethylene polyisocyanates (crude MDI) and mixtures of crude MDI and tolylene diisocyanates (TDI). The organic diisocyanates and polyisocyanates may be used individually or in the form of mixtures thereof. It is likewise possible to use corresponding “oligomers” of the diisocyanates (IPDI trimer based on isocyanurate, biurets, uretdiones). In addition, the use of prepolymers based on the abovementioned isocyanates is possible.

It is also possible to use isocyanates modified by the incorporation of urethane, uretdione, isocyanurate, allophanate and other groups, which are termed modified isocyanates.

Organic polyisocyanates that are particularly suitable and therefore used with particular preference are various isomers of tolylene diisocyanate (tolylene 2,4- and 2,6-diisocyanate (TDI), in pure form or as isomer mixtures of varying composition), diphenylmethane 4,4′-diisocyanate (MDI), “crude MDI” or “polymeric MDI” (containing the 4,4′ isomer and also the 2,4′ and 2,2′ isomers of MDI and products having more than two rings) and also the two-ring product referred to as “pure MDI that is composed predominantly of 2,4′ and 4,4′ isomer mixtures, and prepolymers derived therefrom. Examples of particularly suitable isocyanates are detailed for example in EP 1712578, EP 1161474, WO 00/58383, US 2007/0072951, EP 1678232 and WO 2005/085310, which are hereby fully incorporated by reference.

d) Catalysts

Catalysts d) suitable for the purposes of the present invention are all compounds able to accelerate the reaction of isocyanates with OH functions, NH functions or other isocyanate-reactive groups. It is possible to employ here the customary catalysts known from the prior art, including for example amines (cyclic, acyclic; monoamines, diamines, oligomers having one or more amino groups), ammonium compounds, metalorganic compounds and metal salts, preferably those of tin, iron, bismuth, potassium and zinc. In particular, it is possible to use as catalysts mixtures of more than one component.

Optional component e) may be further surface-active silicon compounds used as additives in order to optimize the desired cell structure and the foaming process. Such additives are accordingly also called foam stabilizers. In the context of this invention, it is possible here to use any Si-containing compounds that promote foam production (stabilization, cell regulation, cell opening, etc.). These compounds are sufficiently well known from the prior art.

Further surface-active Si-containing compounds may be any known compounds suitable for production of PU foam.

Corresponding siloxane structures that are employable for the purposes of the present invention are described for example in the following patent documents, although these describe use only in conventional PU foams, as moulded foam, mattress, insulation material, construction foam, etc.: CN 103665385, CN 103657518, CN 103055759, CN 103044687, US 2008/0125503, US 2015/0057384, EP 1520870 A1, EP 1211279, EP 0867464, EP 0867465, EP 0275563. The abovementioned documents are hereby incorporated by reference and are considered to form part of the disclosure-content of the present invention.

The use of blowing agents f) is in principle optional, depending on which foaming process is used. It is possible to work with chemical and physical blowing agents. The choice of blowing agent here is strongly dependent on the nature of the system.

Depending on the amount of blowing agent used, a foam having high or low density is produced. For instance, foams having densities of 5 kg/m³ to 900 kg/m³ can be produced. Preferred densities are 5 to 350, more preferably 10 to 200 kg/m³, especially 20 to 150 kg/m³.

Physical blowing agents used may be appropriate compounds having suitable boiling points. It is likewise possible to use chemical blowing agents that react with NCO groups to liberate gases such as water or formic acid. Particularly preferred blowing agents comprise for the purposes of the present invention hydrocarbons having 3, 4 or 5 carbon atoms, hydrofluoroolefins (HFO), hydrohaloolefins and/or water.

Additives g) used may be any substances known from the prior art that are used in the production of polyurethanes and PU foams in particular, for example crosslinkers and chain extenders, stabilizers against oxidative degradation (referred to as antioxidants), flame retardants, surfactants, biocides, cell-refining additives, cell openers, solid fillers, antistatic additives, nucleating agents, thickeners, dyes, pigments, colour pastes, fragrances, emulsifiers, etc.

Flame retardants included in the composition according to the invention may be any known flame retardants suitable for production of polyurethane foams. Suitable flame retardants are for the purposes of the present invention preferably liquid organophosphorus compounds such as halogen-free organophosphates, e.g. triethyl phosphate (TEP), halogenated phosphates, e.g. tris(1-chloro-2-propyl) phosphate (TCPP) and tris(2-chloroethyl) phosphate (TCEP), and organic phosphonates, e.g. dimethyl methanephosphonate (DMMP), dimethyl propanephosphonate (DMPP), or solids such as ammonium polyphosphate (APP) and red phosphorus. Other suitable flame retardants are halogenated compounds, for example halogenated polyols, and also solids such as expandable graphite, aluminium oxides, antimony compounds and melamine.

The use according to the invention of polyester-polysiloxane block copolymers makes a reduction in flame retardants possible, which with conventional foam stabilizers leads to inadequate results.

The subject matter of the invention was and is described by way of example hereinbelow, without any intention that the invention be restricted to these illustrative embodiments. Where ranges, general formulas or classes of compounds are stated, these are intended to encompass not only the corresponding ranges or groups of compounds explicitly mentioned but also all subranges and subgroups of compounds that can be obtained by removing individual values (ranges) or compounds. Where documents are cited in the context of the present description, the entire content thereof, particularly with regard to the subject matter that forms the context in which the document has been cited, is fully incorporated into the disclosure content of the present invention. Unless otherwise stated, percentages are in percent by weight. Where average values are stated, these are weight averages unless otherwise stated. Where parameters that have been determined by measurement are stated, the measurements have been carried out at a temperature of 25° C. and a pressure of 101 325 Pa, unless otherwise stated.

The examples that follow describe the present invention by way of example, without any intention that the invention, the scope of application of which is apparent from the entirety of the description and the claims, be restricted to the embodiments specified in the examples.

### EXAMPLES

### Example 1: Synthesis of Polyester-Polysiloxane Block Copolymers

All reactions were carried out under an inert gas atmosphere.

Block Copolymer A:

A 5 L three-necked flask with precision glass stirrer, thermometer and dropping funnel was charged with 813.9 g of 2-allyloxyethanol (CAS: 111-45-5) and this was heated to 100° C. 1.5 g of a toluene solution of Karstedt's catalyst (w (Pt)=2%) was then added. This was followed by the metered addition, over a period of two hours, of 2186.1 g of a siloxane of the general formula Me₃SiO(SiMe₂O)₁₁(SiMeHO)₃SiMe₃. An exothermic reaction commenced. The reaction temperature was maintained between 100 and 110° C. At the end of the metered addition, the mixture was stirred for a further 2 h. Complete conversion of the SiH functions was established gas-volumetrically. The reaction mixture was then heated to 130° C. and stripped of volatiles for 1 h at 1 mbar. A clear, slightly yellowish liquid (step 1) was obtained.

A 5 L three-necked flask with precision glass stirrer and thermometer was charged with 1175 g of step 1 together with 825 g of ε-caprolactone (CAS: 502-44-3), 500 g of dilactide (CAS: 95-96-5) and 2.5 g of Kosmos® 29 (tin catalyst from Evonik). The mixture was stirred at 140° C. for 5 h. A liquid polyester-polysiloxane block copolymer was obtained.

Block Copolymer B:

A 5 L three-necked flask with precision glass stirrer, thermometer and dropping funnel was charged with 500.4 g of 2-allyloxyethanol (CAS: 111-45-5) and this was heated to 100° C. 1.5 g of a toluene solution of Karstedt's catalyst (w (Pt)=2%) was then added. This was followed by the metered addition, over a period of two hours, of 2449.6 g of a siloxane of the general formula Me₃SiO(SiMe₂O)₅₁(SiMeHO)₇SiMe₃. An exothermic reaction commenced. The reaction temperature was maintained between 100 and 110° C. At the end of the metered addition, the mixture was stirred for a further 2 h. Complete conversion of the SiH functions was established gas-volumetrically. The reaction mixture was then heated to 130° C. and stripped of volatiles for 1 h at 1 mbar. A clear, slightly yellowish liquid (step 1) was obtained.

A 5 L three-necked flask with precision glass stirrer and thermometer was charged with 1288 g of step 1 together with 621 g of ε-caprolactone (CAS: 502-44-3), 391 g of dilactide (CAS: 95-96-5) and 2.3 g of Kosmos® 29 (tin catalyst from Evonik). The mixture was stirred at 140° C. for 5 h. A liquid polyester-polysiloxane block copolymer was obtained.

Block Copolymer C:

A 5 L three-necked flask with precision glass stirrer and thermometer was charged with 1175 g of step 1 from synthesis example 1 (see block copolymer A) together with 825 g of ε-caprolactone (CAS: 502-44-3), 500 g of γ-butyrolactone (CAS: 96-48-0) and 2.5 g of Kosmos® 29 (tin catalyst from Evonik). The mixture was stirred at 140° C. for 5 h. A liquid polyester-polysiloxane block copolymer was obtained.

Block Copolymer D:

A 5 L three-necked flask with precision glass stirrer and thermometer was charged with 1288 g of step 1 from synthesis example 2 (see block copolymer B) together with 621 g of 8-caprolactone (CAS: 502-44-3), 391 g of γ-butyrolactone (CAS: 96-48-0) and 2.3 g of Kosmos® 29 (tin catalyst from Evonik). The mixture was stirred at 140° C. for 5 h. A liquid polyester-polysiloxane block copolymer was obtained.

### Example 2: Rigid PUR Foam

The following foam formulation was used for the performance comparison:

| | Proportion |
|---|---|
| Component | by weight |
| Polyether polyol* | 100 |
| Catalyst** | 2 |
| Surfactant*** | 2.5 |
| Water | 2 |
| Cyclopentane | 14 |
| MDI**** | 215 |

*Daltolac ® R 471 from Huntsman, OH value 470 mg KOH/g
**Polycat ® 8 from Evonik Operations GmbH
***Polyester-polysiloxane block copolymers such as those described in example 1 or polyether siloxanes from Evonik Operations GmbH as reference
****Polymeric MDI, 200 mPa*s, 31.5% NCO, functionality 2.7.

The comparative foamings were carried out by manual mixing. This was done by weighing polyol, catalysts, water, surfactant and blowing agent into a beaker and mixing this with a disc stirrer (diameter 6 cm) at 1000 rpm for 30 s. The beaker was reweighed to determine the amount of blowing agent that had evaporated during the mixing operation and this was replenished. The MDI was then added and the reaction mixture stirred with the described stirrer at 2500 rpm for 7 s and immediately transferred to an open mould having dimensions of 27.5×14×14 cm (W×H×D).

After 10 min, the foams were demoulded. One day after foaming, the foams were analysed. The pore structure and surface were assessed subjectively on a scale from 1 to 10, where 10 represents an (idealized) defect-free, very fine foam and 1 represents an extremely defective, coarse foam.

The results are compiled in the table below:

| | | Pore |
|---|---|---|
| Surfactant | Surface | structure |
| Block copolymer A | 7.0 | 7.0 |
| Block copolymer B | 7.0 | 7.0 |
| Block copolymer C | 7.5 | 7.5 |
| Block copolymer D | 7.0 | 8.0 |
| Tegostab ® B 8486 | 7.0 | 6.0 |
| Tegostab ® B 8462 | 7.5 | 7.0 |

The results show that it is possible with block copolymers A-D to achieve pore structures and foam qualities that are at the same level as or better than those of polyether siloxane-based foam stabilizers. Density, compressive strength and thermal insulation performance are affected only negligibly or not at all by the block copolymers of the invention and are at the same level as those of polyether siloxane-based foam stabilizers.

### Example 3: Rigid PUR Foam

The following foam formulation was used for the performance comparison:

| | Proportion |
|---|---|
| Component | by weight |
| Polyether polyol* | 100 |
| Catalyst** | 1.4 |
| Surfactant*** | 3 |
| Water | 2.5 |
| TCPP | 60 |
| 1233zd | 8 |
| MDI**** | 266 |

*Daltolac ® R 471 from Huntsman, OH value 470 mg KOH/g
**Polycat ® 8 from Evonik Operations GmbH
***Polyester-polysiloxane block copolymers such as those described in example 1 or polyether siloxanes from Evonik Operations GmbH as reference
****Polymeric MDI, 200 mPa*s, 31.5% NCO, functionality 2.7.

The comparative foamings were carried out by manual mixing. This was done by weighing polyol, catalysts, water, surfactant, flame retardant and blowing agent into a beaker and mixing this with a disc stirrer (diameter 6 cm) at 1000 rpm for 30 s. The beaker was reweighed to determine the amount of blowing agent that had evaporated during the mixing operation and this was replenished. The MDI was then added and the reaction mixture stirred with the described stirrer at 2500 rpm for 7 s and immediately transferred to an open mould having dimensions of 27.5×14×14 cm (W×H×D).

After 10 min, the foams were demoulded. One day after foaming, the fire behaviour was determined by the small-burner test (B2) in accordance with DIN 4102-1:1998-05.

The results are compiled in the table below:

| | Largest flame |
|---|---|
| Surfactant | height in mm |
| Block copolymer A | 140 |
| Block copolymer B | 130 |
| Block copolymer C | 140 |
| Block copolymer D | 140 |
| Tegostab ® B 8486 | 150 |
| Tegostab ® B 8462 | 160 |

The results show that it is possible with block copolymers A-D to achieve a lower flame height compared with conventional polyether siloxanes and thus an improvement in fire behaviour, and that it is possible to comply with the fire protection standard of min. B2.

All other use-relevant foam properties are affected only negligibly or not at all by the copolymers of the invention.

### Example 4: Rigid (PIR) Polyisocyanurate Foam

The following foam formulation was used for the performance comparison:

| | Proportion |
|---|---|
| Component | by weight |
| Polyester polyol* | 100 |
| Amine catalyst** | 0.6 |
| Potassium trimerization catalyst*** | 3.5 |
| Surfactant**** | 2 |
| Water | 0.8 |
| TCPP | 5 |
| Cyclopentane/isopentane 70:30 | 18 |
| MDI***** | 221 |

*Stepanpol ® PS 2352 from Stepan, OH value 250 mg KOH/g
**Polycat ® 5 from Operations GmbH
***Kosmos ® 75 from Operations GmbH
****Polyester-polysiloxane block copolymers such as those described in example 1 or polyether siloxanes from Evonik Operations GmbH as reference
*****Polymeric MDI, 200 mPa*s, 31.5% NCO, functionality 2.7.

The comparative foamings were carried out by manual mixing. This was done by weighing polyol, catalysts, water, surfactant, flame retardant and blowing agent into a beaker and mixing this with a disc stirrer (diameter 6 cm) at 1000 rpm for 30 s. The beaker was reweighed to determine the amount of blowing agent that had evaporated during the mixing operation and this was replenished. The MDI was then added and the reaction mixture stirred with the described stirrer at 3000 rpm for 5 s and immediately transferred to an open mould having dimensions of 27.5×14×14 cm (W×H×D).

After 10 min, the foams were demoulded. One day after foaming, the foams were subjected to a cone calorimeter test in accordance with ISO 5660-1 AMD 1:2019-08, with the burning time determined at a heating rate of 25 kW/m² as the time between the foam igniting and the flame being extinguished.

The results are compiled in the table below:

| Surfactant | Burning time in s |
|---|---|
| Block copolymer A | 83 |
| Block copolymer B | 151 |
| Block copolymer C | 49 |
| Block copolymer D | 32 |
| Tegostab ® B 8462 | 545 |
| Tegostab ® B 84504 | 440 |

The results show that it is possible with block copolymers A-D to achieve a shorter burning time compared with conventional polyether siloxanes and thus an improvement in fire behaviour. All other use-relevant foam properties are affected only negligibly or not at all by the copolymers of the invention.

1-15. (canceled)

16. A composition for producing polyurethane (PU) foam, comprising at least an isocyanate component, a polyol component, blowing agents, and, optionally, a catalyst that catalyses the formation of a urethane or isocyanate linkage, wherein the composition comprises polyester-polysiloxane block copolymers.

17. The composition of claim 16, wherein polyester-polysiloxane block copolymers of formula 1 are used: 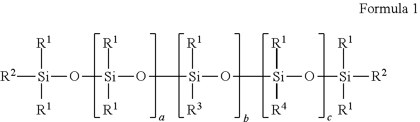
wherein:
R¹=identical or different aliphatic or aromatic hydrocarbon radicals having 1 to 16 carbon atoms;
R²=identical or different radicals from the group R¹, R³ or R⁴;
R³=identical or different polyester radicals;
R⁴=identical or different polyether radicals;
a=5-200;
b=1-20;
c=0-20;
with the proviso that at least one radical R³ must be present in the molecule.

18. The composition of claim 17, wherein:
R¹=aliphatic or aromatic hydrocarbon radicals having 1 to 8 carbon atoms;
R²=R¹;
R³=identical or different polyester radicals of the general formula 2: 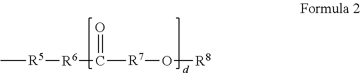
wherein:
R⁵=identical or different divalent alkyl radicals optionally interrupted by one or more oxygen atoms;
R⁶=O or NH or NMe;
R⁷=identical or different divalent alkyl radicals having 1 to 20 carbon atoms;
R⁸=identical or different radicals of general formula —C(O)R¹⁰ or H;
R¹⁰=identical or different alkyl radicals having 1 to 16 carbon atoms;
R⁴=identical or different polyether radicals of the formula 3: 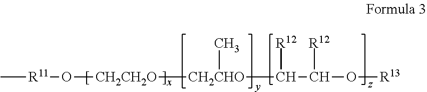
wherein:
R¹¹=identical or different divalent alkyl radicals having 2 to 12 carbon atoms;
R¹²=identical or different alkyl radicals having 1 to 12 carbon atoms;
R¹³=identical or different radicals from the group: —C(O)R¹⁰, H and alkyl radicals having 1-8 carbon atoms;
a=5-100;
b=1-15;
c=0-15;
d=2 to 80;
e=1-16;
x=0 to 80;
y=0 to 80;
z=0 to 60;
with the proviso that x+y+z>2;
and with the proviso that at least two different radicals R⁷ are present in the molecule.

19. The composition of claim 18, wherein:
R¹=methyl or phenyl;
R²=R¹;
R⁵=—(CH₂)₃—, —(CH₂)₆, —(CH₂)₃OCH₂CH₂— or —(CH₂)₃OCH₂CH(CH₃)—;
R⁶=O;
R⁷=alkyl radicals of the general formula —[CR⁹₂]ₑ—;
R⁹=identical or different alkyl radicals having 1 to 8 carbon atoms or H;
R⁸=H;
R¹⁰=methyl;
R¹¹=divalent alkyl radicals having 3 to 6 carbon atoms;
R¹²=methyl, ethyl or phenyl;
R¹³=—C(O)CH₃, H or methyl;
a=10-80;
b=2-10;
c=0;
d=3 to 40;
e=1 to 6;
x=3 to 40;
y=3 to 40;
z=0.

20. The composition of claim 18, wherein the polyester-polysiloxane block copolymers are obtained through reaction of cyclic esters, of the cyclic dimers thereof or of higher analogues with alcohol- and/or amino-functional siloxanes.

21. The composition of claim 20, wherein at least two or more different cyclic esters are used in the production of the polyester-polysiloxane block copolymers.

22. The composition of claim 20, wherein the cyclic esters are selected from the group consisting of: propiolactone; lactide; caprolactone; butyrolactone; and valerolactone.

23. The composition of claim 16, wherein the PU foam is a rigid foam and the polyester-polysiloxane block copolymers are used in a total amount of 0.01 to 15 parts, based on 100 parts of polyols.

24. The composition of claim 23, wherein the polyester-polysiloxane block copolymers are used in a total amount of 0.1 to 10 parts, based on 100 parts of polyols.

25. The composition of claim 23, wherein the polyester-polysiloxane block copolymers are used in a total amount of 0.1 to 5 parts, based on 100 parts of polyols.

26. The composition of claim 16, wherein the composition uses as blowing agents hydrocarbons having 3, 4 or 5 carbon atoms.

27. The composition of claim 16, wherein the composition uses as blowing agents HFC 245fa, HFC 134a and/or HFC 365mfc, perfluorinated compounds, hydrohaloolefins, water, oxygen-containing compounds and/or chlorinated hydrocarbons.

28. The composition of claim 18, wherein the composition uses as blowing agents HFC 245fa, HFC 134a and/or HFC 365mfc, perfluorinated compounds, hydrohaloolefins, water, oxygen-containing compounds and/or chlorinated hydrocarbons.

29. The composition of claim 16, wherein the polyester-polysiloxane block copolymers contain, in addition to the polyester side chains, polyether side chains.

30. The composition of claim 18, wherein the polyester-polysiloxane block copolymers contain, in addition to the polyester side chains, polyether side chains.

31. The composition of claim 16, wherein siloxane-based foam stabilizers comprising exclusively polyethers are present to an extent, based on the total amount of foam stabilizers, of less than 10% by weight.

32. The composition of claim 16, wherein Si-containing foam stabilizers are present to an extent, based on the total amount of foam stabilizers, of more than 20% by weight.

33. The composition of claim 32, wherein Si-containing foam stabilizers are present to an extent, based on the total amount of foam stabilizers, of more than 50% by weight.

34. A process for producing PU foams based on foamable reaction mixtures comprising polyisocyanates, compounds having reactive hydrogen atoms, blowing agents and optionally other additives, wherein the polyester-polysiloxane block copolymers of claim 1 are used.

35. A rigid PU foam, produced by the process of claim 34.
